(19) United States
(12) Patent Application Publication
(10) Pub. No.: US 2006/0206347 A1
(43) Pub. Date: Sep. 14, 2006

(54) Network centric system and method for processing information

(75) Inventor: Clement C. Chen, Bethesda, MD (US)

Correspondence Address: BUCHANAN, INGERSOLL & ROONEY PC, POST OFFICE BOX 1404, ALEXANDRIA, VA, 22313-1404, US

(73) Assignee: Lockheed Martin Corporation

(21) Appl. No.: 11/076,905

(22) Filed: Mar. 11, 2005

(51) Int. Cl. G06Q 99/00

(52) U.S. Cl. 705/1

(57) ABSTRACT

A network centric method and system for processing information, wherein a hierarchical database populated with an organizational construct of an integrated system is accessed to decompose the organizational construct into separate franchises of the integrated system. Each franchise of the integrated system is classified according to a network centric taxonomy for the integrated system. The franchises are allocated across one or more elements of an activity chain for the integrated system. A graphical depiction of at least one of a network-centric view and an activity chain view of the integrated system is made available for display.

### BACKGROUND

As organizations have become more complex and inter-related, systems and methods for identifying areas in need of improvement and opportunities for growth have correspondingly become more complex. Methods for analyzing the information related to organizations, including external audits, process flow studies, and attempts to map existing business structures to an evolving marketplace, can require the expenditure of large resources in terms of time, money, and personnel.

### SUMMARY

A computer-based network centric system is disclosed for processing information, including a hierarchical database populated with an organizational construct of an integrated system; a graphical user interface for displaying a compositional delta associated with at least one of a network centric view and an activity chain view of the integrated system; and a computer processor performing the steps of accessing the hierarchical database to decompose the organizational construct into separate franchises of the integrated system; classifying each franchise according to a network centric taxonomy for the integrated system; allocating each franchise across one or more elements of an activity chain for the integrated system; and determining a compositional delta between the integrated system's organizational construct and a target market construct.

A computer-implemented method is also disclosed, which, when processed by a computer, implements a process for applying a network centric taxonomy to the construct of an entity to determine a channel control strength of one or more franchises of the entity, the process including decomposing a construct of an entity into individual franchises of the entity; classifying each franchise according to a network centric taxonomy for the entity; allocating each franchise across one or more elements of an activity chain for the entity; determining a channel control strength value for each of the franchises; and producing a graphical depiction of at least one of an activity chain view and a network centric view of the franchises of the entity.

A computer readable medium encoded with computer-executable instructions is disclosed, which, when executed by a computer, provides for applying a network centric classification to the organizational construct of an integrated system, wherein the instructions are provided for accessing a hierarchical database populated with an organizational construct of an integrated system to decompose the organizational construct into separate franchises of the integrated system; classifying each franchise according to a network centric taxonomy for the integrated system; allocating each franchise across one or more elements of an activity chain for the integrated system; and producing a graphical depiction of at least one of a network centric view and an activity chain view of the integrated system.

A computer-implemented system is also disclosed for applying a network centric structure of an integrated system to changing market conditions, including means for directing a processor to apply a network centric classification to an organizational construct of an integrated system to decompose the integrated system into its separate franchises; means for allocating each franchise across elements of an activity chain for the integrated system; means for determining a market value of at least one element for each franchise; and means for displaying to a user at least one of a network-centric view, an activity chain view, and a market strength view of the integrated system.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 shows a component diagram of a network centric system for processing information and determining a network centric view of an integrated system.

FIG. 2 shows a component diagram of a network centric system for processing information and determining an activity chain view of an integrated system.

FIG. 3 shows block flow chart of an exemplary network centric method for processing information.

FIG. 4 shows a block flow chart of an exemplary rules-based process for determining a channel control strength of a franchise or activity chain element.

FIG. 5 shows a block flow chart of an exemplary process for determining a corporate resource reallocation based on a determined channel control strength as shown by a compositional delta.

FIG. 6 shows a compositional delta associated with an network centric perspective view of an integrated system.

FIG. 7 shows a compositional delta associated with an activity chain perspective view of an integrated system.

### DETAILED DESCRIPTION OF THE EMBODIMENTS

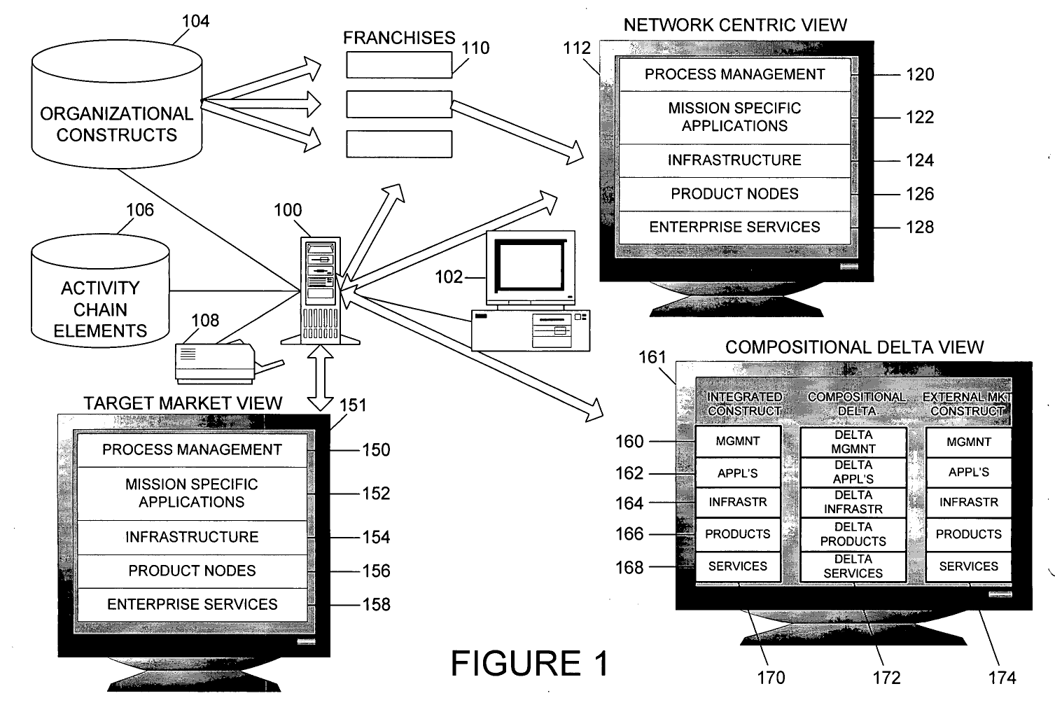

Referring initially to FIG. 1, there is shown a component diagram of a network centric system for processing information. Computer-executable instructions, or software, are provided for directing the processing of the computer 100, including processing the steps of exemplary embodiments of the network centric information processing system. The computer-executable instructions, when executed by the computer 100 and/or at least one processor of the computer 100, provide for the process of applying a network centric structure of an integrated system, such as the organizational construct of a business or other organizational entity, to determine a value of one or more elements of the integrated system. Exemplary embodiments can dissect the organizational construct of an entity and apply a value-based component, such as total annual sales volume or budget, to determine a relative value of the one or more elements as compared to other elements, subsystems, entities, or an external market. Such a relative value can be viewed and utilized as a relative strength (or weakness) within a targeted market, product area, or service arena for effecting focused changes within the organizational entity.

The software can be stored on one or more known media types, such as a hard disk drive, of the computer 100, can be loaded into the memory of the computer 100, or can be stored onto separate storage means, 104 or 106, external to the computer 100. Means for supporting a computer-based system for network centric processing of information include the computer 100 and its one or more processors, along with the software, or computer instructions, for directing the computer and/or processor to apply a network centric structure of an integrated system to determine a strength or value of various elements of the integrated system. A graphical user interface or display 102 comprises means for displaying the results of the processing to a user, including a network-centric view, an activity chain view, and/or a market strength view of the integrated system and/or its franchises.

These and other aspects of the network centric information processing method and system will now be described in greater detail in connection with a number of exemplary embodiments. To facilitate an understanding of the embodiments, many aspects are described in terms of sequences of actions to be performed by elements of a computer system 100 or apparatus, including a processor and a display 102. It will be recognized that in each of the embodiments, the various actions could be performed by specialized circuits, by computer program instructions being executed by one or more processors, or by a combination of both. Moreover, embodiments can additionally be considered to be embodied entirely within any form of computer readable storage medium having stored therein an appropriate set of computer instructions that would cause a processor to carry out the techniques described herein.

The processing of exemplary network centric information processing steps can be implemented through the computer 100 by a user utilizing the computer 100 directly or through a connected or networked personal computer 102 or the like. While not shown in FIG. 1, the processing of exemplary steps can be implemented across a network, such as an intranet, a local area network, or the Internet, such that input information, control parameters, and output results can be transmitted to and from the computer 100 across the network. The user can input various parameters and can select various options, as will be discussed more completely below, to direct the processing of exemplary steps.

Input to the computer 100 is provided in part through two files, an organizational constructs file 104 and an activity chain element file 106. The organizational constructs file 104 can be viewed as an independent source file that reflects the unique organizational profile that is being employed by the user. The activity chain element file 106 can be construed as a dependent derivative file that represents the allocation of the organizational constructs file 104 across the unique activity chain elements for the integrated system of the user. While the files 104 and 106 are shown as databases physically external to the computer 100, exemplary embodiments are not so limited, and the input files can be placed internal to the computer and/or located remotely from the computer 100 and accessible across one or more networks. Similarly, while the structure of the data on the organizational constructs file can be viewed as having a hierarchical structure, the actual format and storage of the file data can take on one or more known data organization and storage forms, including hierarchical databases and sequential files. Output from the processing of the computer can be directed to one or more output devices, including storage devices 104 and 106, printers 108, connected computers 102, and displays 112, 114, and/or 116.

The input file shown on database 104 represents the organizational constructs of the integrated systems to be processed by exemplary embodiments. To facilitate the disclosure of exemplary components and the methodology of the network centric system for processing information, a fictional entity, ACME Autos, will be used in the present disclosure as representative of the integrated systems. ACME Autos, for example and not limitation, designs, manufactures, sells, and maintains automobiles. While a manufacturing business entity, ACME Autos, is being utilized to disclose and explain features of the system, embodiments of the information processing system are not limited to manufacturing entities or businesses for profit. Exemplary embodiments can also be applied to any entity or organization, even a municipality or government organization, including a country, for processing, analyzing, comparing, and producing views of the entity or organization to assist in understanding the structure, products, and services of the entity and to disclose strengths and weaknesses in its organization and/or output.

A top level of the organizational construct for the exemplary ACME Autos can be the corporation itself. The next level in the hierarchy of the organizational construct can be the business area level. This level represents the various businesses of the corporation. For example, ACME Autos can be understood to design, manufacture, market, and service cars and trucks; so one business area could be vehicles. ACME Autos might also offer financing for the purchase of its vehicles through a financial arm. Therefore, another business area for ACME Autos could be financing services. Below the business area level can be a line of business area. For ACME Autos, the lines of business could include the major vehicle divisions, such as Acer, Cruiser, Medallion, and Excell, for example. For some businesses, or integrated systems, the lines of business are the operating units of the business, or corporation.

Next in the hierarchy of the organizational construct is the business segment level. Examples of entries in the business segment level for ACME Autos could be the types of vehicles manufactured, such as sedans, trucks, sports utility vehicles (SUV's), and hybrids. Finally, at the bottom of the organizational construct is the franchise level. The franchise level represents the products and services actually marketed by the corporation, such as, in the case of ACME Autos, could be the specific vehicles of the Acer Speedster, the Cruiser Woody Wagon, the Medallion Salon, and the Excell F-80.

Those skilled in the art will recognize that different corporations can have different organizational, or enterprise, constructs. That is, the hierarchical structure of the corporation will not be the same from corporation to corporation, nor will the structure of a corporation necessarily be the same for a governmental entity. Accordingly, levels can be added and subtracted from the organizational construct described above without detracting from exemplary embodiments. However, each integrated system will have at least two levels—a top corporate level and a bottom franchise/product/service level. Further, the use of the term, “corporation,” is utilized within present embodiments for convenience and not limitation. The use of this term is not intended to limit application of exemplary information processing systems and methods to those organizations, entities, and businesses that are organized as formal corporations. Unincorporated entities, such as partnerships, sole proprietorships, project groups, governmental bodies, and the like, are also considered to be within the definition of “corporation” as used in the exemplary embodiments presented here and can be analyzed by the methods and systems discussed herein.

A user of the system can populate the hierarchical database 104 by loading the organizational constructs of various corporations into the file/database 104. Further, multiple organizational constructs can be loaded for any one corporation, thereby providing the user with the capability of analyzing and testing various constructs of a business under differing product and market conditions.

The franchises of a corporation, including its products and services, can straddle, or overlap several categories. For example, computer services can be applied to onboard gas delivery systems for vehicle engines as well as to payroll services for manufacturing employees. However, most franchises can be classified into one of five categories, or bins, of a network centric taxonomy, as shown by the network centric view 112 of a corporation. These categories include Process Management 120, Mission Specific Applications 122, Infrastructure 124, Product Nodes 126, and Enterprise Services 128. Each of the franchises of these network centric categories represent products and services that are not only marketable externally from the corporation but can also have value as products and services to be utilized internally.

The network centric elements of the corporation can also be loaded into the file/database 104 or can be loaded into a file/database separate from the organizational constructs. While the organizational constructs of a corporation represent the organizational hierarchy the corporation has selected for itself or has organized itself into, the network centric elements of each corporation represent a capabilities-based view of the corporation according to a network centric taxonomy. This new capabilities-based view is derived from categorizing the organizational construct of the corporation across its network centric categories to reveal and present to the user the franchise products and services of the corporation within each network centric category. Similar to the organizational constructs loaded into file/database 104, the network centric elements for each corporation can be selected by a user as a function of how the franchises of the corporation can be categorized or classified within and across the corporation. While any number and type of classes can be defined for the network centric view of the corporation franchises, an exemplary list of classes are shown in the network centric view 112.

The Process Management class 120 represents business processes for planning, directing, coordinating, and controlling corporate resources toward the design, creation, and delivery of marketable franchises. Such processes can also be termed “Command & Control” franchises and include business processes instantiated by software applications. These products legitimately reside within the network centric value chain because they can be marketed, licensed, and/or sold to any number of entity types in need of such process management resources. For example, the proprietary vehicle design processes or dealership inventory management systems of ACME Autos can have value to other manufacturing entities and could be sold to such entities.

Mission Specific Applications 122 are typically software-based processes that are directed to instantiating functions or effects that accomplish a particular mission for the customer. For example, a hypothetical location-based global positioning software system (GPS) could be part of ACME's portfolio of products and services that are sold externally to end customers as a vehicle-integrated option. This application can be fed car location data from the onboard GPS system and could, for example, access one or more databases by means of a wireless link to the Internet to satisfy a driver's query of where the nearest Italian restaurant might be found. The location-based services application is segregable from the vehicle platform in question and can be sold as an option to that vehicle or sold to other manufacturers for inclusion in their vehicles or to edge device manufactures as a valued-added feature of their GPS receivers. Edge devices comprise products that can access a network to receive, transmit, and/or process information, including cellular telephones, personal computers, and Bluetooth compatible devices.

The Infrastructure class 124 represents those franchise resources that facilitate the transport and/or delivery of information among the network centric Process Management, Mission Specific Applications, Product Nodes, and Enterprise Services as shown in view 112. This information conduit stands apart from the actual information content that traverses it and includes networking and communications elements, workstations and terminals, servers, and mass access devices. For ACME Autos, the Infrastructure class 124 can include satellite dishes utilized for the transmission and receipt of wireless-based information signals. However, this class can extend to vehicle satellite receivers for receiving and playing back to the vehicle user satellite radio signals. Such information communication technology can be externally marketable to corporations for effecting the transmission and reception of information among the elements and locations of the corporation and their customers and for enhancing their communication/delivery resources.

While the elements of all of the network centric categories of the corporation can ultimately be made available for marketing, the Product Nodes class 126 represent the products and services that historically comprise the marketable and/or visible output of the corporation. Alternately, the franchises that comprise the Product Nodes class 126 are the products and services along which the corporation can be structured. In the example discussed above, the line of business area for ACME Autos includes the Acer, Cruiser, Medallion, and Excell vehicle product lines, with specific products including the Acer Speedster and the Cruiser Woody Wagon. However, many, if not all, of the resources and output of the corporation can be viewed as franchises that are available for marketing, and thereby generating revenue, outside the corporation. As such, the franchise classes of the network centric view of the corporation can also be perceived as a network centric value chain in that the franchises belonging to each of these categories represent a chain of values that can be used to generate value for the corporation, whether the value is derived as products and services marketed to external customers or the value results from products and services generated by the corporation and made available for use within the corporation.

The Enterprise Services category 128 represents those corporation-wide services that span across the entire network centric value chain of the corporation or are not dedicated to a single platform. For example, the servicing division of ACME Autos, SuperLube, services all the vehicles brought to ACME Autos locations and accordingly provides platform-independent services and corporation-wide services without being tied to a particular product or line of business.

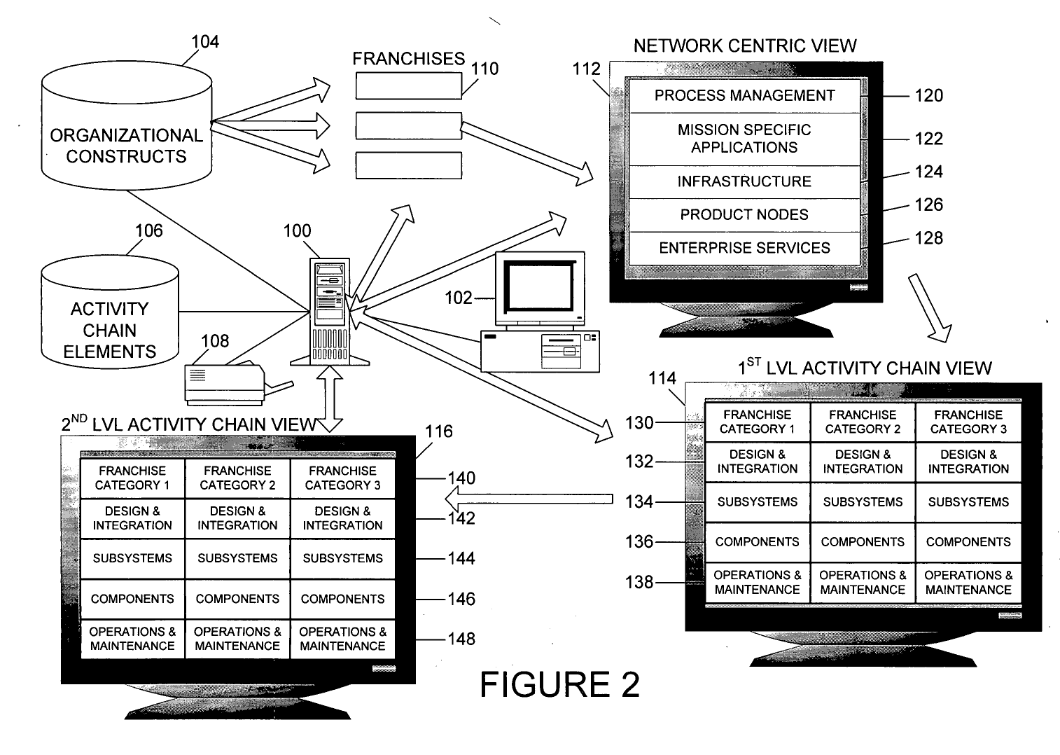

As discussed above, the network centric view 112 of the classification of franchises across the network centric categories 120-128 represents a capabilities-based view of the corporation. In contrast, the activity chain view, 114 and 116, as shown in FIG. 2, represents an activity view of the integrated system, with each franchise allocated across the activity chain elements 132-138 for the corporation. In the activity chain view 114, the dollar value of each franchise is split, or allocated, across the activity chain elements 132-138 such that the total value of each franchise, such as in sales dollars for example, is allocated across the various elements of the corporation's activity chain, as will be explained below.

The user can select and load the particular activity chain elements 130-138 for each franchise into the file/database 106 for subsequent access by the computer 100. The activity chain elements of a franchise are a combination of value-added processes and various levels of system and component aggregation that are employed in the creation of marketable franchises. The activity chain elements of a franchise represent those processes, systems, and components across which the value of the franchise can be allocated in the marketing or the selling of the franchises externally by the corporation. For example, given the ACME Autos franchise, the Medallion Salon, with a market value of, say $30,000, perhaps 10 percent, or $3,000, can be attributed to the design of the Salon and the integration (Design & Integration 132) of its manufacture, sale, and service into the ACME Autos corporate construct. Perhaps 60 percent, or $18,000, of the value of the Salon is attributable to its subsystems, such as its drive train, its electrical system, and its finish. Subsystem elements 134 are those portions of the franchise that can be further broken down into second-level 116 subsystems 144 and/or components 146, which in turn can be broken down into third-level subsystems and/or components, and so on. For example, the drive train subsystem 134 can be broken down into the engine subsystem 144, the transmission subsystem 144, and the differential subsystem 144, each of which can be further broken down into finer subsystems and components, such as bearings and gear assemblies.

Possibly another 10 percent of the value of the vehicle is attributable to the Component elements 136 of the Salon, such as its tires and lights, which cannot be further broken down into subsystems and/or components. Finally, 20 percent can be allocated to the Operations & Maintenance element 138 of the Salon franchise, representing income value attributable to the maintenance and servicing of customer's Salons by the corporation.

Similar to the organizational construct of each corporation and the network centric view 112 of each franchise, the activity chain elements 130-138 can be customized to each franchise and/or business segment. For example, ACME Autos does not manufacture the component tires that are mounted on all the vehicles sold by ACME Autos. Assuming that any maintenance of such tires is the responsibility of the manufacturer, the Design & Integration element 132 would have the total value of the tires; and, in particular, the Integration portion of this element would have the entire share of the value. Subsystems 134 would have no portion of the allocation because tires are not subsystems; and Components 136 would have a zero allocation because the tires are not a franchise of the corporation to market. Operations & Maintenance could have a small portion of the value of the tires representing the service provided to have the tire manufacturer repair or replace the tire for the vehicle owner. Alternately, the activity chain for such items could have only the Design & Integration element 132.

While not shown in FIG. 2, exemplary embodiments provide for multiple activity chain structures within a corporation. For example, for some franchise categories 130, such as ACME Autos' sedan franchise category, the Design & Integration element 132 can be split into a separate Design element and a separate Integration element. Similarly, other activity chain elements can be customized within a corporation and within the organizational construct levels for the corporation.

Referring now to FIGS. 1, 2, and 3, there will be a discussion of an exemplary method for processing enterprise information to determine a market strength and/or difference of one or more subsystems of a franchise. At step 300, the system accesses the hierarchical organizational constructs database 104, and the processor of the computer 100 decomposes the organizational construct of the corporation into the separate franchises 110 of the corporation. As utilized herein, decomposition of the organization construct of the corporation means that the construct of the corporation is mined or broken down to locate, identify, and extract the franchises of the corporation. The decomposed franchises 110 represent the products and services marketed by the corporation. In exemplary embodiments, the franchises also represent the resources, products, and services of the corporation that potentially can be marketed, or are comprised of subsystems and/or components that might be available for separate marketing. The user has the option of limiting the processing to a finite part of the corporation, such as a particular business area or line of business. Alternately, the user can accept for processing the entire organizational construct for a franchise of interest. At each step of the information processing method, the user can view displayed options and results, such as views 112, 114, 116, 151, and 161, and can enter information and commands through a graphical user interface 102.

Each of the franchises 110 are classified in step 302 into corporate-wide categories according to a network centric taxonomy for the integrated system, thereby providing a network centric view 112 of the integrated system. The network centric view 112 can show the various franchises of the integrated system as classified into the respective network centric categories, such as categories 120-128. At step 304, the franchises of the network centric categories are allocated across one or more elements of an activity chain for the integrated system, such as shown in view 114. For example, allocation of the Medallion Salon franchise can provide for allocating the drive train subsystem, the electronics system, the convenience system, and the safety elements system to the subsystems class 134. During this step, the total value of the franchise, e.g., Medallion Salon, is allocated across the elements of the activity chain such that the total of all values allocated equals the value of the franchise, i.e., the Salon, as a whole.

At step 306, the allocation step is optionally repeated wherein the subsystem elements 134 of view 114 are further allocated across the elements of a second-level activity chain 116. For example, a drive train subsystem 134 can be further allocated into engines, transmissions, fuel delivery, and electronic control subsystems 144 and into drive shafts and engine mounts components 146. The drive shafts and engine mounts become allocated to components 146 at this activity chain level because these franchise elements cannot be further broken down and, therefore, are no longer viewed as subsystems. This iterative process of breaking down subsystems into finer subsystems and components can continue through any number of steps (N, N+1, N+2, and so on), dependent only upon the complexity of the franchise and its subsystems and the goals of the user in mining down through the elements of the franchise to further marketable components. In an alternate embodiment, where the franchise lacks any subsystems or where the franchise has only subsystems that decompose into only components, step 306 can be skipped; and the final activity chain view of the franchise can be represented by view 114.

In the situation where a corporation merely assembles the subsystems and the components of a franchise, the corporation can be viewed as a thin integrator of the franchise, and all the value of the franchise could be allocated to the Design & Integration element 132. If, for example, half of the elements of the franchise by value are produced by or are under the control of the corporation, then half of the value would be allocated to Design & Integration and the other half of the value would be allocated to Subsystems 134 and/or Components 136.

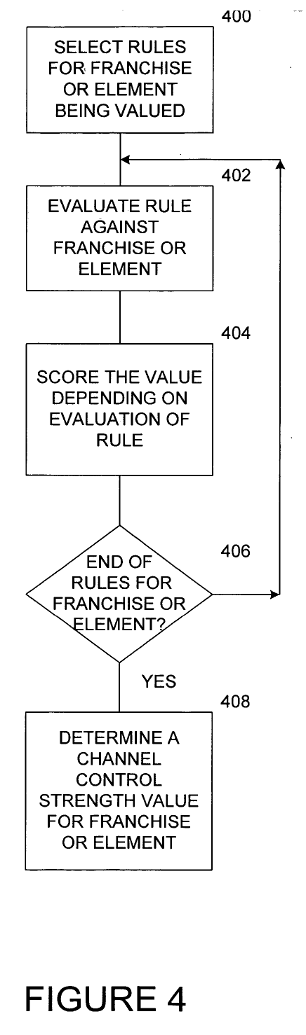

Following the completion of the allocation of the franchise into a desired level of activity chain subsystem and component granularity, a value for each mined-down subsystem and/or component can be qualified at step 308 to determine an internal market value of each such subsystem and/or component. In an exemplary embodiment, the determination of a value that signifies channel control strength can be accomplished by a rules-based process, as shown in FIG. 4. Embodiments provide for different sets of rules to be applied, depending on the franchise or activity chain element being valued and the type of analysis desired by the user. Accordingly, at step 400, a user can select a rules set for valuing the franchise or element. The rules set can be selected from one or more databases, whether such databases reside on storage directly available to the computer 100 or accessible across a network.

At step 402, a rule from the rule set is applied against the franchise or activity chain element. For example, a rule can be proffered that if the corporation sells the subsystem or component (i.e., product, including services) directly, the value of the product can be scored as “high” in a, for example, three level rating system of high, medium, or low. Alternately, a system of numerical scoring can be utilized; for example, a rating of 1-5 with descriptives associated with each level that are automatically triggered based on the rules set(s) that is invoked. Similarly, if the above corporate product selling position is envisioned to change in a direction which distances or brings closer together the vendor with the end customer, then the value of the product can be automatically scored accordingly. Another rule could be based on who the product is sold through, with this element inferring whether this market conduit would be likely to remain open. Yet another rule could be directed to the “ancestry” of the franchise element as the franchise has been mined down to its component subsystems and parts. For example, if the product's ultimate franchise “parent” is an independently marketed platform with a promising or deteriorating (i.e., evolving) future growth prospect, such as a mainframe computer, a personal computer, or a Medallion sedan, the scoring of the product can be reflected automatically. For example, a franchise that is part of a platform with a strong or rising value would be scored high. The ultimate proxy for determining the channel control strength for a particular franchise or product is represented by a composite score along with its associated descriptives which provide a view of the future prospects for the merchant supplier channel of the item in question.

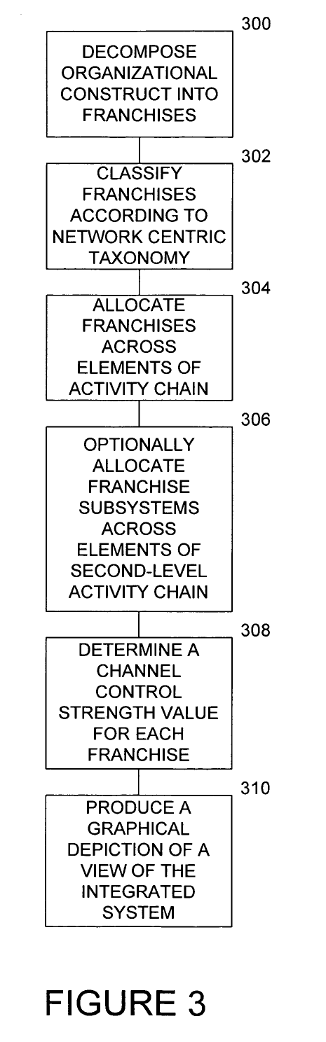

The rules can be further applied based on the perspective of the activity chain element being qualified in and of itself. For example, if the potential product/service being qualified has been allocated to the Design & Integration element 132, and if design and integration services are known to be the performance-defining dimension of value in a particular customer demand function, then the value/channel control strength of this franchise element would be increased accordingly by operation of the rules-based process. At step 406 the rules set is checked for the end of the set. If not, the next rule is applied at step 402; and if the end of the rules set has been reached, the channel control strength value is determined based on the net increase/decrease in value from steps 402 and 404. Each of these rules-based inquiries and evaluations operate to evaluate the business nature of the particular subsystem or component under review, with the net effect of the qualifying process producing a valuation and/or a channel control strength of the activity chain element at step 408, which corresponds to the channel control strength step 308 of FIG. 3.

At step 310, a network-centric view 112, an activity chain view 114, and/or a market strength view 161 of the integrated system can be produced and displayed to the user via the graphical user interface 102. The user has the option of selecting one or more views of the processed integrated system, as shown in FIGS. 1 and 2. The view can be a network centric view 112, wherein the franchises 110 of the integrated system are classified according to a network centric taxonomy for the integrated system and displayed to the user. Such a view reveals the allocation of franchises across the various network centric categories of the corporation, thereby revealing the content of each category and/or the “home” of each franchise. Additionally, one or more activity chain views 114 and 116 of the franchises of the integrated system can be displayed to the user. The activity chain view(s) 114 and 116 can show a single franchise category, such as the sedans franchises of ACME Autos, or can show multiple franchise categories, such as the three franchise categories shown in view 116. Also, a market strength view can be selected for display, wherein the components of the integrated system, such as its network centric classifications, its franchises, and/or its subsystems and components, can be displayed with a measurement of relative market strength and/or value, such as, for example, a network centric view 112 or an activity chain view 114.

Once the value of the activity chain franchise or element is determined according to the above descriptions, this value can be utilized as a common reference point with which to compare the corporate construct and/or allocation of franchises to an external market and/or to a changing market. By comparing the resultant values, whether on a network centric level, an activity chain level, or a franchise/element level, against an external or a changing market, a perspective view of the corporation in the form of a compositional delta can be determined that indicates, by selected level, the differences between the constructs and franchises of the present corporation/market and those of a target market. Exemplary embodiments can compute a compositional delta as a snapshot in time of the differences between any two internal markets, any two external markets, or any internal market vs. any external market. In such an embodiment, the comparison between markets is not limited in time or in perspective and can provide specific values of change between the franchises, network centric categories, and/or activity chain elements of the two respective markets being analyzed.

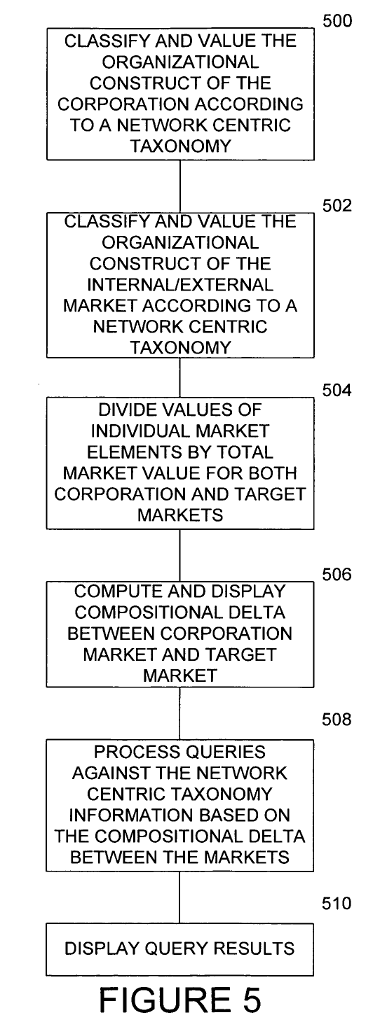

Referring now to FIG. 5, there is shown an exemplary process for determining a corporate resource reallocation based on a computed compositional delta. In step 500, the organizational construct of the corporation is classified into its component franchises and valued according to the description of exemplary embodiments presented above. At step 502, a target market is selected by the user and processed according to exemplary embodiments to correspondingly classify and value the market according to a network centric taxonomy and activity chain allocation. The target market selected can, for example and not limitation, be the composite market of all vehicles sold in the past year. Alternately, if ACME is targeting a particular large user or competitor, the market could be the annual budget for that user or competitor. These markets are examples of external markets against which the corporation and its franchises can be compared by exemplary embodiments to identify areas of commonality and areas of divergence and, therefore, candidates for change and/or reallocation.

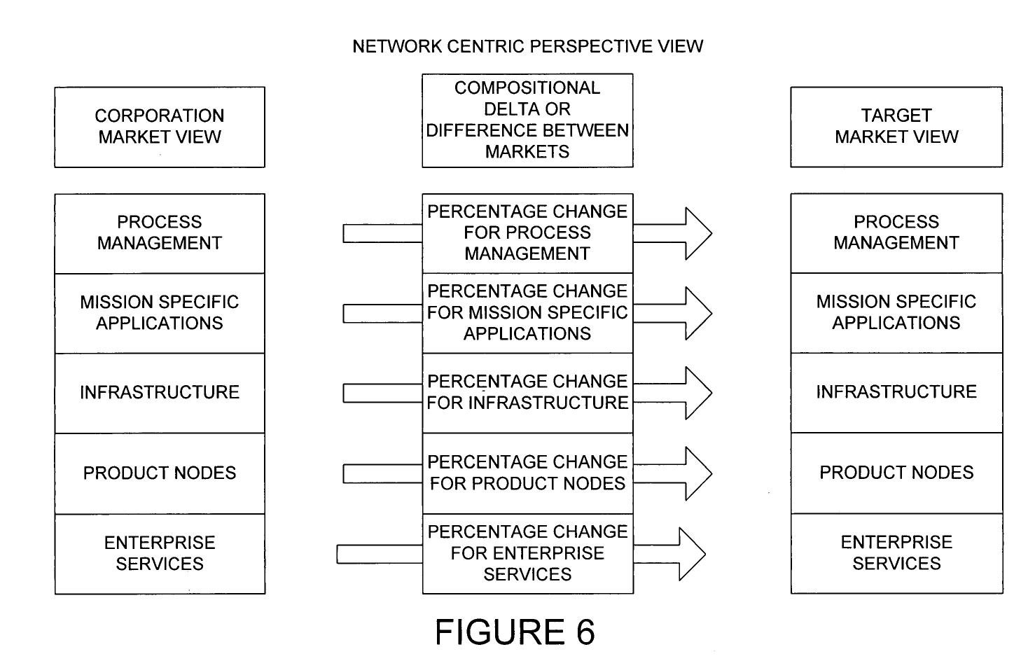

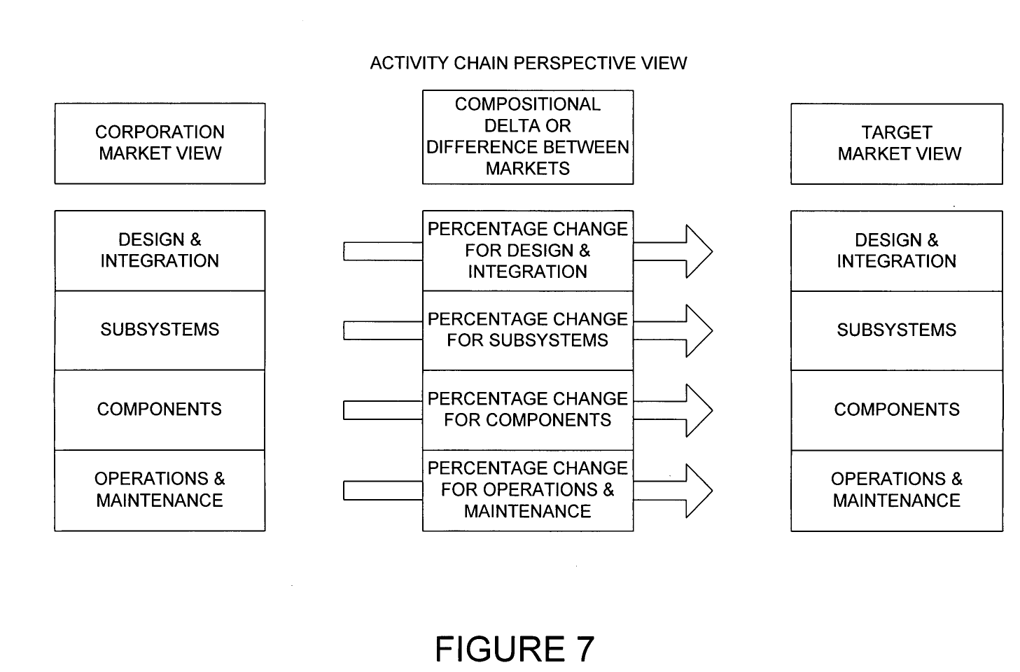

Further, the target market can be anticipatory, such as a projected market for the corporation. In this embodiment, an alternate internal market is constructed based on, for example, an anticipated market for the corporation five years in the future that is either forecast or desired by the corporation. In any event, the construct of the corporation and the construct of the target market as an external or an internal market are classified, allocated, and valued in steps 500 and 502. The values of the individual market categories, franchises, and elements for the corporation and the target market are then divided in step 504 by their respective total market values. The result of this division is a percentage of each market by the respective categories, franchises, and elements. The level of detail to which this analysis and division is carried can be selected by the user and can, for example, be conducted at a network taxonomy level, an activity chain level, an element level, a franchise level, or any combination thereof. The respective percentages of each corporation's market category, franchise, and/or element are compared against the corresponding percentages of the target market to determine, or compute, a difference, or compositional delta, between the corporation market and the target market which can be displayed at step 506 as a compositional delta view 161, as shown in FIGS. 1 and 6. The compositional delta view between the two markets can also be presented from the perspective of the activity chain allocation of the corporation and the target market, as shown in FIG. 7.

Any of the above views can be provided at each and every integrated system level of abstraction in accordance with the selected architecture of the organizational construct. Furthermore, queries can be run in step 508 against the information of the system to provide for any combination of views, augmented by user-selected trending profiles. For example, the system can indicate that ACME has a significant weakness in its mission application product line of sedans based on the compositional delta between its portfolio and that of its targeted market. Queries can then be run to sort and display all of the mission application franchises in ACME, parsed by its existing organizational construct and delineated from highest to lowest selling in a given year. Alternately, a similar query could be entered to sort and display ACME's mission application franchises by the highest to lowest growth rates over a targeted time period. From these or any other set of queries, deficiencies and opportunities are displayed to the user, who can then discern potential patterns at step 510 of activity that provide meaningful input into future business decisions, including determining a corporate resource reallocation based on projected market changes. For example, if the compositional delta for an element is greater than a predetermined maximum, the view 161 or the view shown in FIG. 7 can automatically flag this disparity to the user to not only signal a need to implement changes in at least this element but also to indicate the magnitude of the needed change. Such a relatively large compositional delta can indicate an imbalance between the corporation construct or franchise level and the corresponding level of the target market, thereby indicating a needed resource change or reallocation to reposition the corporation to be more closely aligned with the target market.

Although preferred embodiments of the present invention have been shown and described, it will be appreciated by those skilled in the art that changes may be made in these embodiments without departing from the principle and spirit of the invention, the scope of which is defined in the appended claims and their equivalents.

What is claimed is:

1. A computer-based network centric system for processing information, comprising:
a hierarchical database populated with an organizational construct of an integrated system;
a graphical user interface for displaying a compositional delta associated with at least one of a network centric view and an activity chain view of the integrated system; and
a computer processor performing the steps of:
accessing the hierarchical database to decompose the organizational construct into separate franchises of the integrated system;
classifying each franchise according to a network centric taxonomy for the integrated system;
allocating each franchise across one or more elements of an activity chain for the integrated system; and
determining a compositional delta between the integrated system's organizational construct and a target market construct.

2. The system according to claim 1, wherein allocating each franchise includes allocating a portion of a value of each franchise to one or more elements of the franchise.

3. The system according to claim 2, wherein the value of the franchise is measured as a function of sales revenue generated by the franchise.

4. The system according to claim 1, wherein the processor produces a graphical depiction of the network centric classification of the organizational construct.

5. The system according to claim 1, wherein at least one element of the activity chain comprises a subsystem and wherein the processor also performs the step of allocating each subsystem element across one or more elements of a second-level activity chain.

6. The system according to claim 5, including repeating a step of allocating each (N)-level subsystem across one or more elements of a (N+1)-level activity chain, wherein at least one element of the (N+1)-level activity chain is comprised of a (N+1)-level subsystem and wherein N is an integer greater than 1.

7. The system according to claim 5, including determining, by a rules-based process, a channel control strength for each franchise.

8. The system according to claim 1, wherein the processor also performs the steps of:
decomposing a construct of a target market into separate franchises of the target market;
classifying each target market franchise according to the network centric taxonomy for the integrated system;
allocating each target market franchise across one or more elements of the activity chain for the integrated system;
determining a compositional delta between the integrated system's organizational construct and the target market construct based on the value of the franchises of each market; and
displaying the compositional delta.

9. The system according to claim 8, wherein the target market comprises an external market or an internal market.

10. The system according to claim 8, wherein the composition delta indicates a magnitude of difference between the organizational construct and the target market.

11. The system according to claim 8, wherein the composition delta represents a magnitude of corporate resource reallocation to bring the organizational construct into balance with the target market.

12. The system according to claim 1, including determining, by a rules-based process, a channel control strength for each franchise.

13. A computer-implemented method, which, when processed by a computer, implements a process for applying a network centric taxonomy to the construct of an entity to determine a channel control strength of one or more franchises of the entity, the process comprising:
decomposing a construct of an entity into individual franchises of the entity;
classifying each franchise according to a network centric taxonomy for the entity;
allocating each franchise across one or more elements of an activity chain for the entity;
determining a channel control strength value for each of the franchises; and
producing a graphical depiction of at least one of an activity chain view and a network centric view of the franchises of the entity.

14. The method according to claim 13, including populating a hierarchical database with an organizational construct of the entity, wherein the step of decomposing the construct of the entity includes accessing the hierarchical database and breaking down the organizational construct of the entity into the separate franchises of the entity.

15. The method according to claim 13, wherein the organizational construct of the entity includes one or more of corporation level, business area level, line of business level, business segment level, and franchise level.

16. The method according to claim 15, wherein the franchise level is the lowest level of identifiable products and services available for marketing for the entity.

17. The method according to claim 13, wherein the network centric taxonomy for the entity represents a capabilities-based view of the entity.

18. The method according to claim 13, wherein the network centric taxonomy for the entity includes the categories of process management, mission specific applications, infrastructure, product nodes, and enterprise services.

19. The method according to claim 13, wherein the elements of the activity chain include design & integration, subsystems, components, and operations & maintenance.

20. The method according to claim 19, including allocating each franchise into their one or more subsystems.

21. The method according to claim 20, wherein the one or more subsystems represent the individual products and services that are individually marketable.

22. The method according to claim 13, including:
applying rules to each franchise for determining a channel control strength for each franchise.

23. The method according to claim 22, wherein the franchise value is based on market sales.

24. A computer readable medium encoded with computer-executable instructions, which, when executed by a computer, provides for applying a network centric classification to the organizational construct of an integrated system, wherein the instructions are provided for:
accessing a hierarchical database populated with an organizational construct of an integrated system to decompose the organizational construct into separate franchises of the integrated system;
classifying each franchise according to a network centric taxonomy for the integrated system;
allocating each franchise across one or more elements of an activity chain for the integrated system; and
producing a graphical depiction of at least one of a network centric view and an activity chain view of the integrated system.

25. The computer readable medium according to claim 24, including determining a channel control strength for each franchise.

26. The computer readable medium according to claim 24, wherein at least one element of the activity chain comprises a subsystem.

27. The computer readable medium according to claim 26, wherein allocating each franchise includes allocating a portion of a value of the franchise to one or more subsystems of the franchise.

28. The computer readable medium according to claim 26, including allocating each subsystem across one or more elements of a second-level activity chain.

29. The system according to claim 28, including determining a channel control strength of each second-level element.

30. The computer readable medium according to claim 29, wherein allocating each franchise includes allocating a portion of a value of the franchise to one or more second-level elements of the franchise.

31. The system according to claim 30, wherein the value of the franchise is measured as a function of sales revenue generated by the franchise.

32. The system according to claim 24, including producing a graphical depiction of the network-centric classification of the organizational construct.

33. A computer-implemented system for applying a network centric structure of an integrated system to changing market conditions, comprising:
means for directing a processor to apply a network centric classification to an organizational construct of an integrated system to decompose the integrated system into its separate franchises;
means for allocating each franchise across elements of an activity chain for the integrated system;
means for determining a market value of at least one element for each franchise; and
means for displaying to a user at least one of a network-centric view, an activity chain view, and a market strength view of the integrated system.
